(19) United States
(12) Patent Application Publication
(10) Pub. No.: US 2026/0291412 A1
(43) Pub. Date: Sep. 24, 2026

(54) SMART CONVERTER FOR A SYNCHRONOUS MOTOR

(71) Applicant: SAFRAN ELECTRONICS & DEFENSE, PARIS (FR)

(72) Inventor: François GUILLOT, MOISSY CRAMAYEL (FR)

(21) Appl. No.: 18/721,480

(22) PCT Filed: Dec. 20, 2022
(86) PCT No.: PCT/FR2022/052445

§ 371 Date: Jun. 10, 2026

(30) Foreign Application Priority Data
Dec. 20, 2021 (FR) FR2114024

(51) Int. Cl. H02P 6/18

(52) U.S. Cl. CPC H02P 6/186

(57) ABSTRACT

A smart converter for a synchronous motor includes transistors for converting DC current into AC current on each phase line, one current sensor per phase line and a smart control unit controlling each transistor so as to form, on each line, an overall AC voltage signal including a superimposition of an AC-power voltage signal with a measurement signal having a frequency at least 20 times greater than the first frequency of the power signal. The smart control unit demodulates the signals from the current sensors in order to identify two possible angular positions of the rotor and extract, at the same time, a sign of a 2nd-order harmonic of the current from each measurement signal in order to estimate the angular position of the rotor from among the two identified possible angular positions of the rotor.

### TECHNICAL FIELD OF THE INVENTION

The technical field of the invention is that of converters for permanent magnet rotor synchronous motors.

The present invention relates to a smart converter for a synchronous motor and in particular to a rectifier inverter converter for evaluating the rotor position without a sensor, as well as to a system comprising the converter and the synchronous motor.

### TECHNOLOGICAL BACKGROUND OF THE INVENTION

There are different types of synchronous motor, including the synchronous motor with a permanent magnet rotor. It is known to use a rectifier inverter converter to convert a DC voltage into an AC voltage to supply phases of the synchronous motor in order to create a stator rotating field Hs. During operation of this motor, an AC voltage is therefore applied to the windings of a stator, and an AC current generated from the applied voltage circulates through the windings. The feature of a synchronous motor is that its speed of rotation depends on the supply frequency of the phases and/or the amplitude of the stator rotating field Hs. It has thus been known to use a rotor angle measurement sensor (encoder or resolver) for detecting the exact position of the rotor as well as the speed of rotation of the rotor. This enables the converter to adjust the supply frequency as a function of the rotor position, to maintain an angle 9 of 90° between the stator rotating field Hs and a rotor field Hr, so that the motor torque can always be maximal.

However, in some applications, especially in aeronautics, it is difficult to integrate speed sensors into the rotor of the synchronous machine, especially when the environment is very hostile or difficult for maintenance. For example, such rotation sensors should withstand high thermal stresses, in particular, there is a need to use synchronous motors on aeroplanes that can go from a temperature of 45° C., for example on a tarmac, to a negative temperature of −70° C. when the aeroplane is at high altitude. Furthermore, these rotation sensors can be subject to other stresses, such as dust, humidity etc. . . . All these stresses lead to a reduction in the MTBF (Mean Time Between Failure) of a repairable system.

There is also a solution for remotely measuring the angular position of the motor by measuring the EMF between phases for a given current (amplitude and phase), but this solution requires a start-up sequence at a very low excitation frequency so that the motor naturally locks onto the rotating flow, resulting in start-up with virtually zero torque. It is therefore not possible to start with a starting torque.

There is therefore a need to know the angular position and speed of the rotor, in synchronous motor applications in an environment hostile to rotation sensors without starting torque restrictions.

### SUMMARY OF THE INVENTION

The invention offers a solution to the problems previously discussed, by making it possible to obtain information on the angular position of the rotor by using its magnetic influence on the inductance of the stator winding.

One aspect of the invention relates to a smart converter for a synchronous motor comprising:
two inputs to be connected to a DC source,
at least N phase lines to be connected to a phase of the synchronous motor, N being at least equal to or greater than 3,
a rectifier inverter block comprising an arm of transistors per phase line, each connected between both inputs and comprising an output connected to a corresponding phase line for converting the direct current at the inputs into alternating current on the corresponding phase line,
a measurement block comprising one current sensor per phase line for each measuring a current in the corresponding phase line, and each producing an overall current signal representative of the current in the phase lines measured by the current sensors,
a smart control unit comprising:
   a control block connected to a control member of each transistor of the rectifier inverter block to control them, the control block being configured to transmit a control signal to each transistor to form, on each line, an overall alternating voltage signal, the overall alternating voltage signals being phase shifted from one another by 360°/N, each overall alternating voltage signal, each comprising the superimposition:
      of an alternating power voltage signal having a first amplitude value according to a first frequency between a first and a second value,
      with a measurement signal having a second amplitude less than the first amplitude and a second frequency at least 20 times greater than the second value of the first frequency,
      such that the measurement signals are phase shifted from each other by 360°/N,
   a calculation block for estimating the angular position of the rotor comprising a first demodulator block and a second demodulator block, connected to the measurement block to receive the overall current signals representative of the currents in the phase lines by the measurements of the current sensors, the calculation block for estimating the angular position of the rotor being configured to:
      receive an overall signal representative of the current in a line by each corresponding current sensor,
      demodulate each overall current signal by the first demodulator block at the second frequency, in order to extract a demodulated measurement signal at a time instant t, and to identify a current value of each demodulated measurement signal, and to identify two possible angular positions of the rotor as a function of the values of each demodulated measurement signal at the time instant t,
      simultaneously demodulate each overall signal by the second demodulator at a value of twice the second frequency in order to extract, at a time instant t, a sign of an order-2 harmonic of the current of each measurement signal, and
      estimate the angular position of the rotor as a function of the sign of the harmonic identified from both possible angular positions of the rotor identified.

By virtue of the invention, it is possible to obtain information about the angular position as well as the speed of the rotor without an angular position sensor and without electronics close to the synchronous motor, while still being able to start with torque. Indeed, the smart converter can be offset from the synchronous motor and thus disposed in a regulated environment that is much less hostile than that of the synchronous motor. The synchronous machine can thus be free of the physical rotation sensor installed on the mechanical shaft of the rotor, which is costly, of large overall size and sensitive to the environment (due to mechanical oscillations, temperature, noise due to cutting of the power converter, etc.). The smart control unit thus makes it possible to have an overall voltage on each phase output line comprising a first sinusoidal power voltage having the first frequency and a superimposed measurement voltage having the second frequency. The stator windings of the synchronous machine will produce an induced current resulting from this overall voltage and the value of the impedance of each winding as a function of position. Indeed, the rotor, comprising at least one pair of poles, will influence the magnetic path for each stator winding which is a function of the angular orientation of its poles and therefore modify magnetic permeability of the resulting circuit, leading to modification of the stator inductance as a function of angular position.

The current sensors each measure amplitudes and phases of the currents induced in the motor and, as the impedance of each phase winding varies in the stator as a function of the position of the rotor, the smart control unit can detect the position of the rotor. Indeed, by virtue of the superimposition of the measurement signal on the power signal, and its high frequency, the control unit can deduce, by demodulating each overall induced current signal, by the frequency of the control signals, two angular positions of the rotor since the control signals vary according to the inductance of the phase windings and therefore the position of the rotor.

Especially the first demodulator makes it possible to identify two possible angular positions of the rotor and the second demodulator uses measurements of the even harmonics generated by the asymmetry, in the cycle B=f(H), by the influence of the magnetism of the rotor in order to determine to distinguish a North pole from a South pole of the rotor, and thus to distinguish the possible angular position of the rotor among the two rotor positions determined.

High-frequency excitation by the overall alternating voltage signal of each of the N phases with sinusoidal power and measurement signals are phase shifted from one another by 360°/N, i.e. for 3 phases by 120° with respect to one another. For example, with 6 phases, the signals will be 60° phase shifted and the indeterminacy will be removed by a combinatorial analysis of the phase sign of 2 amplitudes H2.

In other words, each measurement signal is phase shifted with each other measurement signal.

For example, in the case of N=3, the control signals for each transistor make it possible to produce three high-frequency measurement signals which are emitted with a phase shift of 120° between them, so that the connection point of the 3 stator windings has a mean potential of zero. Under these conditions, and by synchronous demodulation of the high frequency emitted, the amplitude of the 3 induced high frequency currents is extracted. The impedance variations caused by the magnetic influence of the rotor cause the high-frequency current variations. Then, by deducing the high-frequency amplitudes H1 on the 3 phases and observing, for example, the 3 amplitudes, it is possible to deduce two possible angular positions. Thus, the relative measurement of these 3 currents makes it possible to identify 2 angular positions over 360°. The signs of the phases of the components H2 are then determined in order to remove the indeterminacy of the angular position (one possible angular position from the two previously provided).

The invention thus uses multiphase excitation (each phase line receives an overall AC voltage signal comprising a measurement signal) and uses existing current sensors to measure power currents of each motor phase. The high-frequency components (via the control signals) of the measured currents are extracted by synchronous demodulation via H1 and H2. In practice, this may mean adding digital processing functions to the inverter drive component. In this same inverter drive component performing the digital function, all the measurement and drive functions are gathered. This thus makes it possible to have a common (digital) processing member with perfect control of the relative phases between the transmitted measurement signals HF (H1) and the synchronous demodulation signals, thus enabling their performance to be fully optimised.

Further to the characteristics just discussed in the previous paragraph, the smart converter according to one aspect of the invention may have one or more additional characteristics from among the following, considered individually or according to any technically possible combinations:
According to one embodiment, the rectifier inverter block comprises a filtering block comprising one LC filter per phase line, each LC filter comprises:
   an inductor on the phase line connected between the connection point of the two transistors t of a corresponding arm and a phase output of the stator of the synchronous machine,
   a capacitor connected between the corresponding phase line and the second, so-called negative, input connected to the negative terminal of the battery,
   wherein each current sensor is mounted to the phase line to measure its current between the phase output and the filter block. This makes it possible to measure each phase line current resulting after the LC low-pass filter by extracting the components H1 and H2 (harmonic 2 of H1) by the estimation calculation block producing synchronous demodulation (IQ to get rid of the phase rotations brought by the LC filters). Indeed, an upstream measurement is more difficult to carry out because the spectrum is much richer in HF components, so the measurement is less accurate. On the other hand, phase rotations brought by the filters require in this example to perform IQ demodulations, which are admittedly more complicated to perform but which are digitally controlled in a digital component.
According to one example of this embodiment, the connection point of each capacitor on the phase line is located between the corresponding inductor and the phase output, and the current is measured between the connection point of each capacitor on the phase line and the phase output.
According to one embodiment, the smart converter for a synchronous motor comprises an inverter drive component performing digital functions performing functions of the blocks of the smart control unit. Thus the inverter drive component can furthermore perform the calculation block for estimating the angular position of the rotor and perform all the other inverter measurement and drive functions in order to perform the function of the control block. This thus enables the processing member (the smart digital control unit) to be common in order thus to perform the control block and the calculation block for estimating the angular position of the rotor, thus perfectly controlling the relative phases between the measurement signals HF (H1) emitted and the synchronous demodulation signals, thus enabling their performance to be fully optimised.
According to one embodiment, the smart control unit comprises a function for verifying consistency of the current values of each demodulated measurement signal, and for estimating a majority voting solution in the event of a fault being detected between these current values. This makes it possible to use the redundancy of the measurement block used by the smart control unit in the system.
According to one embodiment, the measurement signal has a second amplitude at least 5 times less than the first amplitude.
According to one embodiment, each transistor of the rectifier inverter block is controlled by the smart unit by high frequency pulse width modulation and in that the rectifier inverter block further comprises one LC filter per phase line. This makes it possible to supply the motor with a voltage close to a sinusoidal signal.
By high-frequency pulse width modulation, it is meant from a few hundred kHz to a few MHz (i.e. between 1 and 3 MHz). This frequency range is easily filtrable by the L,C filter (a capacitor and an inductor) to create pseudo-sinusoidal voltages. This makes it possible to limit radio frequency emissions via a three-phase cable transporting electric energy between the converter and the electric motor. This further reduces partial discharges in the stator windings, which can lead to short-circuits in the winding between two conductors that have been damaged related to partial discharges. Furthermore, this reduces high-frequency currents in the ball bearings of the motor, reducing their life time.
According to one embodiment, the control unit comprises a memory comprising drive laws related to the intrinsic characteristics of the synchronous motor.
According to one embodiment, the smart control unit comprises a memory including four angular position values per value of a mean RMS current of the demodulated measurement signal and in that the control unit identifies the two angular position values common to the different values of a mean RMS current of the demodulated measurement signal at the time instant t.
According to one embodiment, the first value of the first frequency is equal to 0 Hertz and the second value of the first frequency is equal to 1000 Hz.
According to one embodiment, the first and second demodulators are synchronous modulator demodulators and wherein the demodulated measurement signal represents amplitudes of the high-frequency current pulse RMS currents.

According to one embodiment, the second demodulator block comprises one modulator per current sensor for verifying the sign of the order-2 harmonic of the corresponding measurement signal.

Another aspect of the invention relates to a supply system comprising:
the smart converter according to the first aspect of the invention with or without the different characteristics described in the previous paragraphs, and
a synchronous motor comprising a stator comprising phase outputs each connected to a corresponding phase line of the smart converter.

According to one embodiment, the system further comprises a battery comprising two terminals each connected to a corresponding input of the smart converter.

By battery, it is meant one or more electric energy storage units, together enabling a DC voltage to be output between these two terminals.

Another aspect of the invention relates to a method for supplying the supply system according to the aspect of the invention described previously, comprising the steps of:
receiving a speed command,
controlling the transistors of the rectifier inverter block in order to supply the phases of the synchronous motor, according to an overall alternating voltage signal such that it comprises an alternating voltage power signal having a first amplitude value according to a first frequency, as a function of the speed command, and furthermore a measurement signal superimposed on the power signal, the measurement signal having a second amplitude less than the first amplitude (for example by at least 10 times) and a second frequency at least 20 times greater than the second value,
transmitting overall current signals representative of the currents in the phase lines measured by the current sensors,
demodulating each overall current signal by the first demodulator block and by the second demodulator simultaneously,
estimating an angular position value of the rotor at different time instants t, comprising the sub-steps of
   at each time instant t, measuring a value for each demodulated measurement signal and identifying for each demodulated measurement signal angular position values corresponding to the value identified at the time instant t,
   identify two possible angular position values which are common in the different angular position values corresponding to the values of the different demodulated measurement signals at each time instant t,
   identifying the sign, of the value at each time instant t, of each signal demodulated by the second block and estimating the angular position of the rotor relative to the stator from both possible angular position values as a function of at least one identified sign.

Another aspect of the invention relates to a method for acquiring drive laws related to the intrinsic characteristics of the synchronous motor, for a supply system according to the aspect of the invention described previously, wherein a synchronous motor identical to that of the supply system is mounted to a bench with a rotation sensor, and in that the method for acquiring drive laws comprises the steps of
supplying the phases of the synchronous motor via the rectifier inverter block according to the overall alternating voltage signal in which the alternating voltage power signal has a first predetermined amplitude value at a first predetermined frequency, and
measuring, at different time instants t, an angular position value and the overall current signals,
demodulating, for each different time instant t measured, each overall current signal into a value of each measurement signal demodulated by the first demodulator block, as well as identifying the sign of each overall current signal demodulated by the second block, and
storing a correspondence between these values of measurement signal demodulated and the angular position value as well as the sign of each signal demodulated by the second demodulator block.

The invention and its different applications will be better understood upon reading the following description and upon examining the accompanying figures.

### BRIEF DESCRIPTION OF THE FIGURES

The figures are set forth byway of indicating and in no way limiting purposes of the invention.

FIG. 1 represents an electrical schematic diagram of a supply system comprising a smart converter according to one embodiment of the invention.

FIG. 2a represents an operating schematic diagram of the smart converter supplying a synchronous motor.

FIG. 2b represents a diagram representative of the alternating voltages supplying the motor stator in relation to a complete revolution of a rotor.

FIG. 3 represents a diagram representative of the values of an impedance image of the stator windings as a function of the angular position of the rotor, for one complete revolution of the rotor.

FIG. 4 represents a diagram representative of the high-frequency component of the measurement currents demodulated by a demodulator block of the smart converter, for one complete revolution of a rotor.

FIG. 5 represents the diagram of FIG. 4 with two identified possible angular position values of the rotor over one complete revolution of this same rotor.

FIG. 6a represents a schematic diagram of a calculation block for measuring the different harmonics making up the current flowing through the stator supply lines and of the elements for finally calculating angular position by the control unit of the smart converter of FIG. 1.

FIG. 6b represents a schematic diagram of one example of a calculation block for estimating the angular position of the rotor of a smart control unit of the smart converter of FIG. 1.

FIG. 7 represents three different positions of the rotor relative to the stator as well as a graph of the magnetic induction field B as a function of the magnetic field intensity B=f (H) per position, each with an operating point corresponding to the corresponding rotor position.

### DETAILED DESCRIPTION

The figures are set forth byway of indicating and in no way limiting purposes of the invention.

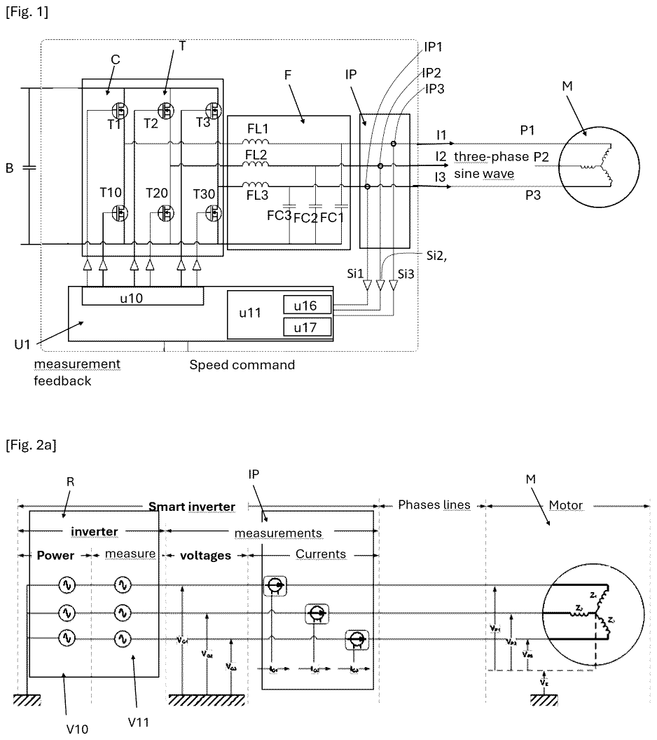

FIG. 1 shows a schematic representation of a system for supplying a synchronous motor M with a smart converter C. The synchronous motor M comprises N phases, in this example N is equal to three for three phases but could include others, for example five or six phases forming a double three-phase. In this example, the synchronous motor M has its phases star-connected but could be delta-connected.

The smart converter C comprises one phase line P1, P2, P3 per phase of the motor M, i.e. in this example a first, a second and a third phase line respectively referenced P1, P2, P3 each connected to a corresponding phase of the synchronous motor.

The smart converter C according to this embodiment can be offset from the synchronous machine M, for example a multiphase, herein three-phase, cable several metres long to connect each phase line L1, L2, L3 of the smart converter C to the corresponding phase of the synchronous machine M. Thus the smart converter C can be installed in an environment less restrictive for the electronics than the synchronous machine M. For example, in an aeroplane, the synchronous machine may be located in an environment subject to large variations in temperature, for example in the landing gear or in the turbomachine or even inside the aeroplane wings, whereas the smart converter C may be installed in a temperature-controlled cabinet, for example in the fuselage.

The smart converter C comprises two inputs each connected to a corresponding terminal of a battery B. The voltage at the output of the battery is DC voltage and can be high, for example 1000V.

The smart converter C comprises a rectifier inverter block R between both inputs and the phase lines P1, P2, P3.

The rectifier inverter block R comprises an arm T1, T2, T3 of transistors t per phase line P1, P2, P3, each connected between both inputs and comprising an output connected to a corresponding phase line P1, P2, P3 for converting the direct current at the inputs into alternating current on the corresponding phase line P1, P2, P3.

In this embodiment, the rectifier inverter block R is of conventional type but could be another type of rectifier inverter.

Each arm T1, T2, T3 of transistors t is therefore connected in parallel with the other arms T1, T2, T3 of transistors t between both inputs. The rectifier inverter block R comprises, for the first arm T1 of transistors t, a transistor t1 connected to a first, so-called positive, input, and a second transistor t2 connected between the first transistor t1 and the second, so-called negative, input. The first phase line P1 is thus connected between the first transistor t1 and the second transistor t2. The rectifier inverter block R thus comprises a third transistor t3 and a fourth transistor t4 forming the second arm T2 identically to the first arm T1 as well as a fifth transistor t5 and a sixth transistor t6 forming the third arm T3 identically to the first arm T1.

Furthermore, in this exemplary embodiment, the rectifier inverter block R optionally comprises a filtering block F comprising an LC filter per phase line P1, P2, P3. Each LC filter comprises an inductor FL1, FL2, FL3 on the phase line P1, P2, P3, i.e. each connected between the connection point of the two transistors t of a corresponding arm T1, T2, T3 and a phase output of the stator of the synchronous machine M. Each LC filter further comprises a capacitor FC1, FC2, FC3 connected between the corresponding phase line P1, P2, P3, and the second so-called negative input connected to the negative terminal of the battery B. In this case, the connection point of each capacitor on the phase line is located between the corresponding inductor and the phase output.

The smart converter C further comprises a measurement block IP comprising a current sensor IP1, IP2, IP3 per phase line P1, P2, P3 each to measure a current 11, 12, 13 in the corresponding phase line P1, P2, P3. Thus, in this example, the first current sensor IP1 produces a first overall current signal Si1 representative of the current 11 in the first phase line P1. The second and third current sensors IP2, IP3 each produce a second and third overall current signal Si2, Si3 respectively representative of the current 12, 13 in the second and third phase line P2, P3 respectively. The current sensors may, for example, be of the IT current transformer type, but may also be according to other types, such as shunt or any other type of current sensor with sufficient bandwidth for the measurements. In this example comprising the filter option, preferably each current sensor IP1, IP2, IP3 is mounted to the phase line to measure the current between the phase output and the filter block. In this example, the current is measured between the connection point of each capacitor on the phase line and the phase output.

The smart converter C further comprises a smart control unit U1 comprising a control block u10 connected to a control member of each transistor t of the rectifier inverter block R to control them in order to form a sinusoidal voltage on each phase line P1, P2, P3. Thus the current 11, 12, 13 flowing through each phase line P1, P2, P3 makes it possible to supply phases of the synchronous machine M.

The smart control unit U1 further comprises a calculation block for estimating the angular position of the rotor u11 connected to the current sensors IP1, IP2, IP3 to receive each overall current signal Si1, Si2, Si3.

In this example, the smart control unit U1 is an inverter drive component performing digital functions performing functions of the calculation blocks for estimating the angular position of the rotor u11 and of the control block u10. Thus the inverter drive component can furthermore perform digital functions of the calculation block for estimating the angular position of the rotor with common measurements of the measurement block IP also enabling other inverter measurement and drive functions to be performed to perform the function of the control block (by closed loop).

The smart control unit U1 uses its control block u10 to control the transistors t of the rectifier inverter block R as a function of a speed command and a value for the angular position φr1 of the rotor estimated in the calculation unit u11 for estimating the angular position of the rotor.

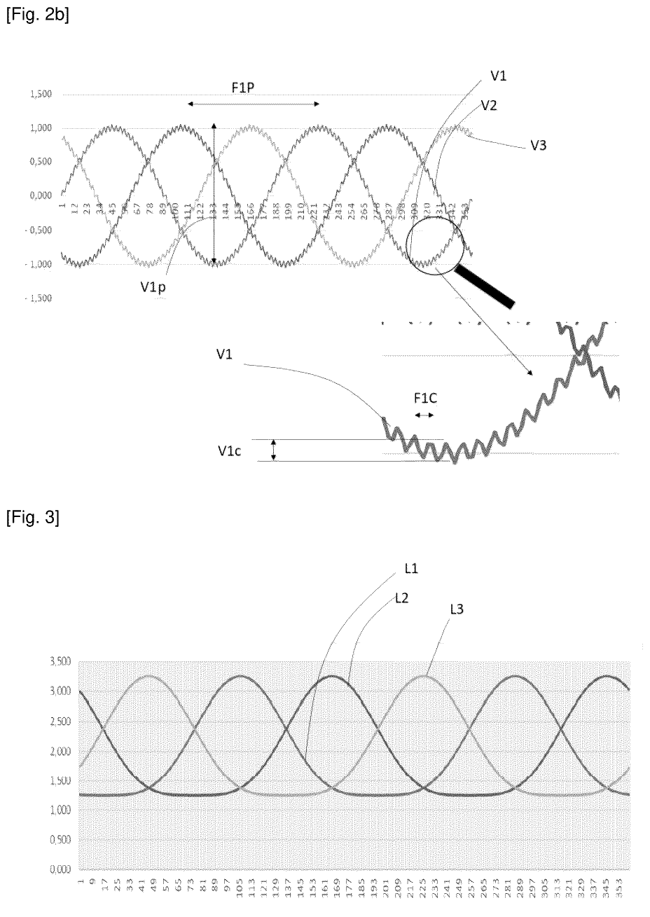

In particular, the control block u10 is configured to transmit a control signal to each transistor t1, t2, t3, t4, t5, t6 to form, on each phase line P1, P2, P3, an overall alternating voltage signal V1, V2, V3 to form a three-phase network such as, for example, that represented in FIG. 2b, each comprising a superimposition of two signals detailed below.

FIG. 2a represents an operating principle diagram of the smart converter supplying a synchronous motor.

Each overall voltage alternating signal V1, V2, V3 comprises a voltage alternating power signal V10 (referenced in FIG. 2a) having a first amplitude value V1P according to a first frequency F1P (represented in FIG. 2b) according to the battery voltage and the speed command. For example, here the first frequency F1P is 500 Hz with an amplitude of 2000 volts (2 times 1000 volts). The control block u10 is configured to produce this alternating voltage power signal V10 in a frequency range between a first minimum value and a second maximum value. In this example, the second value is equal to 500 Hz, i.e. in this example the synchronous motor is rotating at maximum speed. The synchronous motor has, for example, 10 pairs of poles in the stator, i.e. in this example a speed of rotation of 3000 rpm.

As can be seen in FIG. 2b, each overall alternating voltage signal V1, V2, V3 comprises a measurement signal V11 (referenced in FIG. 2a) superimposed on the power signal. By superimposed, it is meant that each overall alternating voltage signal V1, V2, V3 is one single signal comprising both signals V10 and V11, schematically represented separately in FIG. 2a for better understanding but are gathered as represented in FIG. 2b.

As the overall AC voltage signals are 360°/N phase shifted with each other, each overall AC voltage signal, herein 120° (as each AC power voltage signal is conventionally 360°/N phase shifted). The same applies to the measurement signals, which are phase shifted by 360°/N from each other.

An enlargement of part of the first overall alternating voltage signal V1 is represented to show this superimposed measurement signal V11. This measurement signal undulates, according to a second amplitude V1c at least 5 times less than the first amplitude V1p, herein 100 volts, i.e. about 5% of the amplitude V1p of the alternating power signal (20 times less).

The measurement signal further has a second frequency F1C at least 20 times greater than the second value of the first frequency F1P, herein 50 times greater, i.e. 25,000 Hz.

The measurement signal has a sinusoidal shape.

When the rotor of the synchronous motor rotates, it modifies impedance of the windings of each phase of the stator as a function of the angular position of the rotor. Indeed, the rotor, comprising at least one pair of poles, will influence the magnetic path for each stator winding as a function of the angular orientation of its poles, thus modifying magnetic permeability of the resulting circuit, leading to modification of the stator inductance as a function of the angular position.

FIG. 3 represents a graph representative of the values of an image of impedances L1, L2, L3 of the stator windings as a function of the angular position of the rotor, for one complete revolution of the rotor.

On the ordinate, it can be seen in the graph the impedance image L1, L2, L3 of each stator phase as a function of the angular frequency of the phase supply voltage, i.e.: [Lω (Ω)], which varies for the present example in a ratio of from 1 to 3.25, and on the abscissa it can be seen the different values of angular rotation of the rotor relative to a reference point, i.e. between 1° and 360°.

Modelling of the graph of FIG. 3 allows an image of the inductance Z to be represented, thus showing a variation in reluctance which is not purely sinusoidal. This model is given by way of example only and may be adapted to other rotor geometries:

$$Z = L \cdot ωϕ = [ {L}_{0} + {k}_{1} \cdot Sin ( 2 ϕ ) + {k}_{2} \cdot Sin ( 4 ϕ ) ] \cdot ω with$$

φ=angular position of the rotor, 0 to 360°
ω=supply voltage angular frequency, in this case 25000.2π.
The deformation is brought by the component Sin(4φ).

This variation in the impedance of the stator windings is mainly a function of the rotor topology and is a function of the angular position of the rotor due to the variable reluctance effect (magnetic path depending on the position of the rotor relative to the stator). Thus this variation in the impedance of the stator windings has an influence on the low relative permeability path offered to the 25,000 Hz alternating magnetic field emitted by the stator. The amplitudes of each current 11, 12, 13 of each phase line P1, P2, P3 at 25,000 Hz are therefore dependent on the angular position of the rotor. The calculation block for estimating the angular position of the rotor u11 can therefore estimate a value for the angular position of the rotor from the overall current signals Si1, Si2, Si3 representative of the currents 11, 12, 13 in the phase lines P1, P2, P3 by the measurements of the current sensors IP1, IP2, IP3.

In this example, the rotor comprises a single pair of poles thereafter.

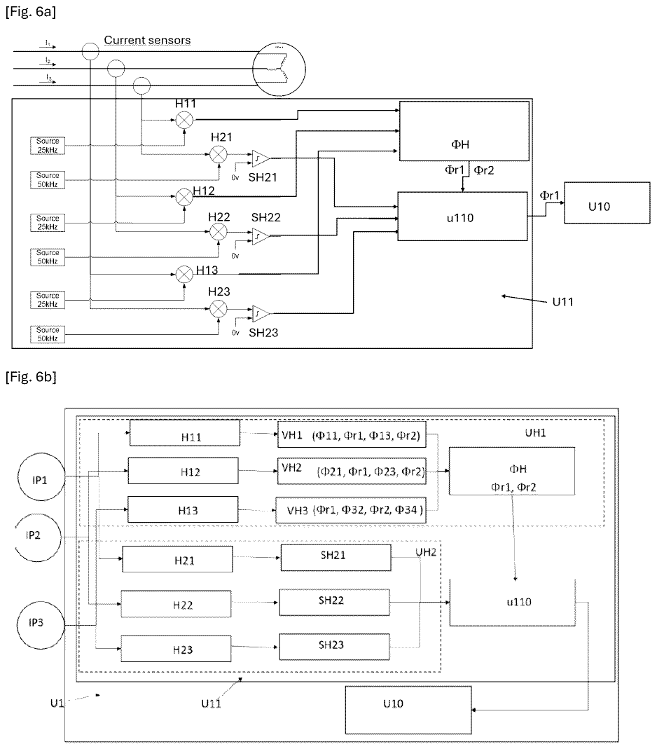

The calculation block for estimating the angular position of the rotor u11 is represented according to a schematic diagram in FIGS. 6a and 6b. The calculation block for estimating the angular position of the rotor u11 comprises a first demodulator block UH1 and a second demodulator block UH2 represented in FIG. 6b. Each of the two demodulator blocks UH1 and UH2 demodulates each overall current signal Si1, Si2, Si3.

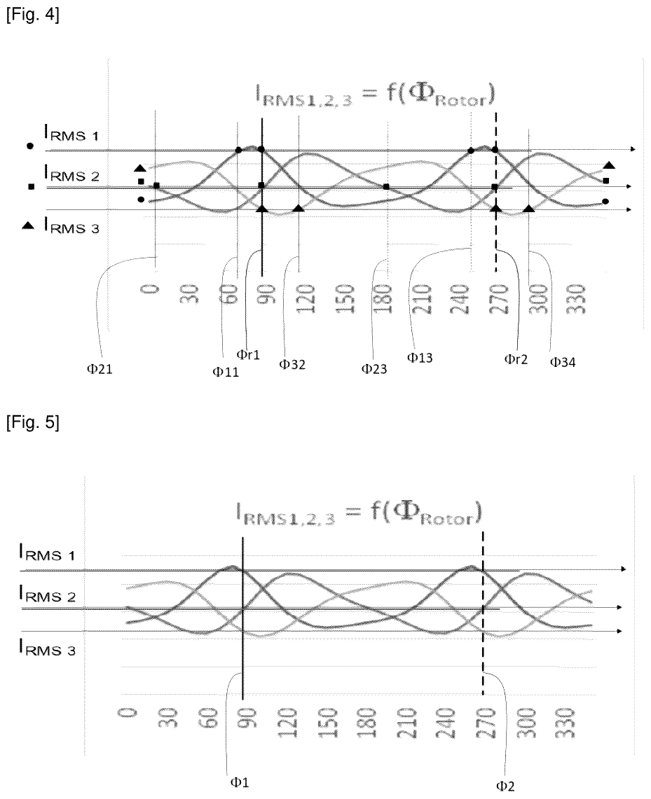

The first demodulator block demodulates each overall current signal Si1, Si2, Si3 at the second frequency F1C, in order to extract, at a time instant t, a demodulated measurement signal Irms1, Irms2, Irms3, a current value of the demodulated measurement signal Irms1, Irms2, Irms3, represented in FIG. 4. Herein, the value is a Root Mean Square (RMS) current value.

Thus, the first demodulator block UH1 comprises a demodulator H11, H12, H13 (referenced in FIGS. 6a and 6b) per overall current signal Si1, Si2, Si3 received in order to output the harmonic component 1 of each of the three currents. Each demodulator H11, H12, H13 is as represented in FIG. 6a and thus comprises a multiplier which thus multiplies the overall current signal Si1, Si2, Si3 by the value equal to the second frequency F1C, i.e. here in this example 25,000 Hz, in order to output order-1 harmonics.

In this example, each demodulated measurement signal Irms1, Irms2, Irms3 comprises four possible angular positions of the rotor per current value demodulated by the demodulator block UH1.

For example, the first demodulated measurement signal Irms1 corresponding to the first current 11 has, for a current value measured at a time instant t, for example here approximately equal to 100 mA (milliamperes), represented by a line and circles intersecting the first demodulated measurement signal Irms1, a first value φ11 approximately equal to 70°, a second value φr1 approximately equal to 90°, a third value φ13 approximately equal to 270° and a fourth value φr2 approximately equal to 240° (visible in FIG. 4).

The same applies to the second demodulated measurement signal Irms2 whose value measured at time instant t is equal to, for example, 100 mA (amperes), represented by a line and squares intersecting the second demodulated measurement signal Irms2, has a first value φ21 approximately equal to 0°, a second value φr1 approximately equal to 90°, a third value φ23 approximately equal to 190° and a fourth value φr2 approximately equal to 240° (visible in FIG. 4).

The same applies to the third demodulated measurement signal Irms2 whose value measured at time instant t is equal to, for example, 100 mA (amperes), represented by a line and triangles intersecting the third demodulated measurement signal Irms2, has a first value φr1 approximately equal to 90°, a second value φ32 approximately equal to 120°, a third value φr2 approximately equal to 240° and a fourth value φ34 approximately equal to 290° (visible in FIG. 4).

The first demodulator block UH1 comprises, for example, an extractor VH1, VH2, VH3 per demodulator H11, H12, H13 for extracting a possible angular positioning value φ11, φr1, φ13, φr2, φ21, φ32, φ23, φ34 according to the current value at a time instant t for each demodulated measurement signal (Irms1, Irms2, Irms3). In FIG. 6a, the position value extractor function is directly performed in a common value identifier φH, as explained below.

Thus the first demodulator block UH1 measures at each time instant t, a value for each demodulated measurement signal Irms1, Irms2, Irms3 and identifies for each demodulated measurement signal Irms1, Irms2, Irms3, angular position values φ11, φr1, φ13, φr2, φ21, φ32, φ23, φ34 corresponding to the value identified at time instant t.

Finally, the first demodulator block UH1 comprises a common value identifier φH, angular position values φ11, φr1, φ13, φr2, φ21, φ32, φ23, φ34 identified for each value measured at time instant t of the demodulated measurement signals Irms1, Irms2, Irms3.

For example, in the example of FIG. 4, at time instant t each demodulated measurement signal Irms1, Irms2, Irms3 has the angular position value of the rotor φr1, φr2, extracted by the extractor VH1, VH2, VH3 respectively for each current value at time instant t of the demodulated measurement signal Irms1, Irms2, Irms3 respectively.

Thus the common value identifier φH makes it possible to identify these two possible angular position values φr1, φr2, as represented in FIG. 5.

Thus, the second demodulator block UH2 comprises a demodulator referenced H21, H22, H23 respectively (visible in FIGS. 6a and 6b) per overall current signal Si1, Si2, Si3 received to identify even harmonics, herein in this example order-2 harmonics. Each demodulator H21, H22, H23 comprises a multiplier which thus multiplies the overall current signal Si1, Si2, Si3 by a value equal to twice the second frequency F1C, that is in this example 50,000 Hz.

The second demodulator block UH2 comprises a reader referenced SH21, SH22, SH23 respectively per overall current signal Si1, Si2, Si3 to read each positive or negative sign of the order-2 harmonics of each overall current signal Si1, Si2, Si3. In the example represented in FIG. 6a, the reader is a comparator with the value 0.

The second demodulator block UH2 may further comprise a sign calculator, receiving from the reader each positive or negative sign of the order-2 harmonics of each overall current signal Si1, Si2, Si3 and in that the calculator averages the quadratic values according to the different signs, in order to determine therefrom a value of its sign (positive or negative) of the second harmonic H2.

Finally, the calculation block for estimating the angular position of the rotor u11 comprises an angular position estimator of the rotor u110 to estimate the position value (φr) from among both possible angular position values φr1, φr2, as a function of the positive or negative signs of the order-2 harmonics received by the readers. In the two examples represented in FIGS. 6a and 6b, the rotor angular position estimator u110 performs the sign calculation function to estimate the angular position among the two possible positions received from the common value identifier φH.

Herein, in this example, the angular position φr1 is equal to 90°.

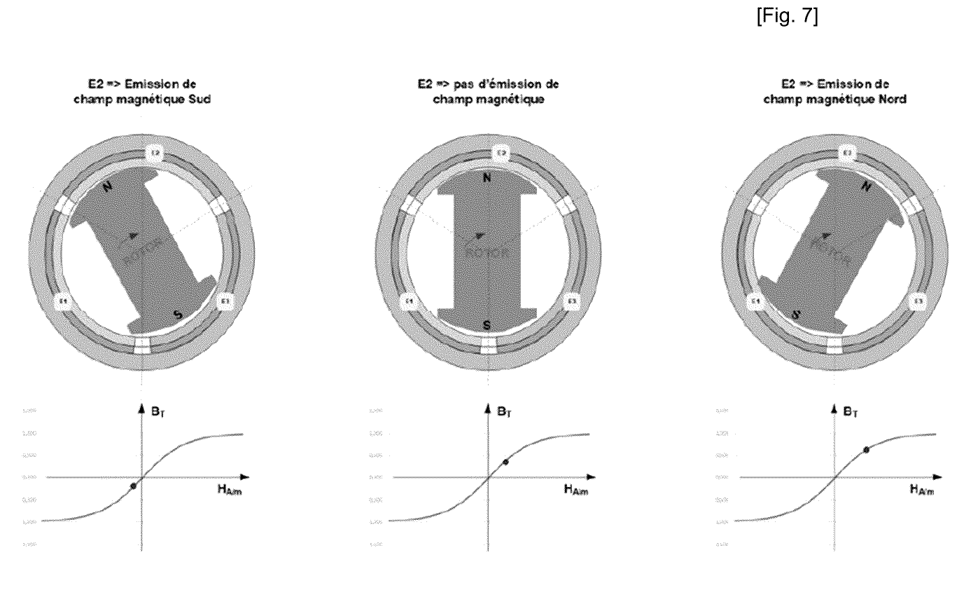

In fact, the fact that the rotor has magnets introduces an external field onto the stator, and causes the operating point to be shifted on the function B=f(H) whose current wave deformation will be asymmetrical. As represented in FIG. 7, which represents three different positions of the rotor relative to the stator, as well as a graph of the magnetic induction field B as a function of the magnetic field intensity B=f (H) per position, each with an operating point corresponding to the corresponding rotor position.

This asymmetry results in the appearance of even harmonics. Indeed, each current 11, 12, 13 flowing in each phase line P1, P2, P3 will therefore cause the operating point to shift on the function B=f(H), the even harmonic of which is dependent on the position in the cycle. In other words, sometimes the positive alternation, sometimes the negative alternation will be more deformed, according to which side around the point O of the B=f(H) cycle this is located.

Thanks to the demodulators H21, H22, H23 and by means of the value of H2, by the value of its sign (positive or negative) it can be known whether the shift in the cycle B=f(H) is due to a North pole or a South pole of the rotor and thus deduced whether the angular position of the rotor has as its value the first or the second possible angular position φr1, φr2.

According to one example, not represented, the calculation block for estimating the angular position of the rotor u11, further comprises a order-4 demodulator, and an order-4 harmonic reader to compare results with those of the order-2. This makes it possible to have a significantly higher amplitude, which makes it possible to improve sensitivity of the calculation block for estimating the angular position of the rotor u11 in particular when the position is close to 360°.

For motors with more than one pair of poles on the rotor, the angular position is calculated over 360 divided by the number of pairs of poles, i.e.:
180° for 2 pairs of poles
120° for 3 pairs of poles
90° for 4 pairs of poles

In these examples, as the rotor comprises more than one pair of poles, the angular position of the rotor is not estimated over 360°, but the control block u10 drives the synchronous motor supply over 360°/by the number of pairs of poles and not over 3600.

The invention also relates to a method for supplying the previously described supply system comprising the steps of:
receiving a speed command,
controlling the transistors of the rectifier inverter block R in order to supply the phases of the synchronous motor, according to an overall alternating voltage signal V1, V2, V3 such that it comprises an alternating voltage power signal having a first amplitude value V1P according to a first frequency F1P, as a function of the speed command, and furthermore a measurement signal superimposed on the power signal, the measurement signal having a second amplitude at least 10 times less than the first amplitude and a second frequency at least 20 times greater than the second value,
transmitting overall current signals Si1, Si2, Si3 representative of the currents 11, 12, 13 in the phase lines P1, P2, P3 measured by the current sensors IP1, IP2, IP3,
demodulating each overall current signal Si1, Si2, Si3 by the first demodulator block UH1 and by the second demodulator block UH2 simultaneously,
estimating at different time instants t an angular position value of the rotor comprising the sub-steps of:
at each time instant t, measuring a value for each demodulated measurement signal Irms1, Irms2, Irms3 and identifying for each demodulated measurement signal Irms1, Irms2, Irms3 angular position values φ11, φr1, φ13, φr2, φ21, φ32, φ23, φ34 corresponding to the value identified at time instant t,
identifying two possible angular position values φr1, φr2 which are common in the different angular position values φ11, φr1, φ13, φr2, φ21, φ32, φ23, φ34 identified corresponding to the values of the demodulated measurement signals Irms1, Irms2, Irms3 different at each time instant t,
identifying the sign, of the value at each time instant t, of each signal demodulated by the second block UH2 and estimating the angular position φr1 of the rotor with respect to the stator from both possible angular position values φr1, φr2 as a function of at least one sign identified.

Finally, given that the variation of the impedance of the stator windings is mainly a function of the topology of the rotor and is a function of the angular position of the rotor by the variable reluctance effect (magnetic path depending on the position of the rotor with respect to the stator). The invention also relates to a method for acquiring drive laws related to the intrinsic characteristics of the synchronous motor, for a supply system described previously, in which a synchronous motor identical to that of the supply system is mounted to a bench with a rotation sensor, and in that the method for acquiring drive laws comprises the steps of:
supplying the phases of the synchronous motor via the rectifier inverter block R according to the overall alternating voltage signal in which the alternating voltage power signal has a first predetermined amplitude value V1P at a first predetermined frequency F1P, and
measuring, at different time instants t, an angular position value and the overall current signals Si1, Si2, Si3,
demodulating, for each different time instant t measured, each overall current signal Si1, Si2, Si3 into a value of each measurement signal Irms1, Irms2, Irms3 demodulated by the first demodulator block UH1 as well as identifying the sign of each overall current signal Si1, Si2, Si3 demodulated by the second block UH2 and
storing a correspondence between these demodulated measurement signal values Irms1, Irms2, Irms3 and the angular position value as well as the sign of each signal demodulated by the second demodulator block UH2.

Unless otherwise specified, a same element appearing in different figures has a unique reference.

1. A smart converter for a synchronous motor comprising:
two inputs to be connected to a DC source,
at least N phase lines to be connected to a phase of the synchronous motor, N being at least equal to or greater than 3,
a rectifier inverter block comprising an arm of transistors per phase line, each connected between both inputs and comprising an output connected to a corresponding phase line to convert the direct current at the inputs into alternating current on the corresponding phase line,
a measurement block comprising one current sensor per phase line each to measure a current in the corresponding phase line, and each to produce an overall current signal representative of the current in the phase lines measured by the current sensors,
a smart control unit comprising:
a control block connected to a control member of each transistor of the rectifier inverter block in order to control them, the control block being configured to transmit a control signal to each transistor to form, on each line, an overall alternating voltage signal the overall alternating voltage signals being phase shifted from one another by 360°/N, each overall alternating voltage signal each comprising the superimposition:
1. of an alternating power voltage signal having a first amplitude value according to a first frequency between a first and a second value,
2. with a measurement signal having a second amplitude less than the first amplitude and a second frequency at least 20 times greater than the second value of the first frequency,
3. such that the measurement signals are phase shifted from each other by 360°/N,
a calculation block for estimating the angular position of the rotor comprising a first demodulator block and a second demodulator block, connected to the measurement block to receive the overall current signals representative of the currents in the phase lines by the measurements of the current sensors, the calculation block for estimating the angular position of the rotor being configured to:
1. receive an overall signal representative of the current of a line by each corresponding current sensor,
2. demodulate each overall current signal by the first demodulator block at the second frequency, to extract a demodulated measurement signal at a time instant t, and to identify a current value of each demodulated measurement signal, and to identify two possible angular positions of the rotor as a function of the values of each demodulated measurement signal at time instant t,
3. simultaneously demodulate each overall signal by the second demodulator at a value of twice the second frequency to extract at a time instant t a sign of an order-2 harmonic of the current of each measurement signal, and
4. estimate the angular position of the rotor as a function of the sign of the harmonic identified from both possible rotor angular positions identified.

2. The smart converter according to claim 1, wherein each transistor of the rectifier inverter block is controlled by the smart unit by high frequency pulse width modulation and in that the rectifier inverter block further comprises one LC filter per phase line.

3. The smart converter according to claim 1,
wherein the control unit comprises a memory comprising drive laws related to intrinsic characteristics of the synchronous motor.

4. The smart converter according to claim 1, wherein the smart control unit comprises a memory comprising four angular position values per value of an RMS current of the demodulated measurement signal and in that the control unit identifies the two common angular position values to the different values of an RMS current of the demodulated measurement signal at time instant t.

5. The smart converter according to claim 1, wherein the first value of the first frequency is equal to 0 Hertz and the second value of the first frequency is equal to 1000 Hz.

6. The smart converter according to claim 1, wherein the first and second demodulators are synchronous modulator demodulators and wherein the demodulated measurement signal is representative of the amplitudes of the high frequency current pulse RMS currents.

7. The smart converter according to claim 1, wherein the second demodulator block comprises one modulator per current sensor for verifying the sign of the order-2 harmonic of the corresponding measurement signal.

8. A supply system comprising:
the smart converter according to claim 1,
a synchronous motor comprising a stator comprising phase outputs each connected to a corresponding phase line of the smart converter.

9. A method for supplying the supply system according to claim 8, comprising:
receiving a speed command,
controlling the transistors of the rectifier inverter block to supply the phases of the synchronous motor, according to an overall alternating voltage signal such that it comprises an alternating voltage power signal having a first amplitude value according to a first frequency, as a function of the speed command, and furthermore a measurement signal superimposed on the power signal, the measurement signal having a second amplitude less than the first amplitude and a second frequency at least 20 times greater than the second value,
transmitting overall current signals representative of the currents in the phase lines measured by the current sensors,
demodulating each overall current signal by the first demodulator block and by the second demodulator simultaneously,
estimating an angular position value of the rotor at different time instants t, comprising the sub-steps of
at each time instant t, measuring a value for each demodulated measurement signal and identifying for each demodulated measurement signal values of angular position corresponding to the value identified at time instant t,
identifying two possible angular position values which are common in the different angular position values identified corresponding to the values of the demodulated measurement signals different at each time instant t,
identifying the sign, of the value at each time instant t, of each signal demodulated by the second block and estimating the angular position of the rotor with respect to the stator from both possible angular position values as a function of at least one identified sign.

10. A method for acquiring drive laws related to intrinsic characteristics of the synchronous motor, for a supply system according to claim 8, wherein a synchronous motor identical to that of the supply system is mounted to a bench with a rotation sensor, and in that the method for acquiring drive laws comprises:
supplying the phases of the synchronous motor via the rectifier inverter block according to the overall alternating voltage signal in which the alternating voltage power signal has a first predetermined amplitude value at a first predetermined frequency, and
measuring, at different time instants t, an angular position value and the overall current signals,
demodulating, for each different time instant t measured, each overall current signal into a value of each measurement signal demodulated by the first demodulator block as well as identifying the sign of each overall current signal demodulated by the second block, and
storing a correspondence between these demodulated measurement signal values and the angular position value as well as the sign of each signal demodulated by the second demodulator block.
